(19) United States
(12) Patent Application Publication
(10) Pub. No.: US 2026/0358647 A1
(43) Pub. Date: Nov. 12, 2026

(54) OPTICAL SYSTEM AND DISPLAY APPARATUS HAVING THE SAME

(71) Applicant: CANON KABUSHIKI KAISHA, Tokyo (JP)

(72) Inventor: Kazutaka INOGUCHI, Tokyo (JP)

(21) Appl. No.: 19/657,153

(22) Filed: Apr. 24, 2026

(30) Foreign Application Priority Data
May 9, 2025 (JP) 2025-078407

(51) Int. Cl. G02B 27/28; G02F 1/13363

(52) U.S. Cl. CPC G02B 27/286; G02F 1/133638

(57) ABSTRACT

An optical system includes, in order from a display element side toward an observer side, a circular polarization-selective reflective polarizer configured to reflect first circularly polarized light having a polarization direction of a first rotational direction, a half-transmissive reflective surface, a first quarter waveplate, and a first absorptive linear polarizer. The optical system has an optical path in which second circularly polarized light having a polarization direction of a second rotational direction opposite to the first rotational direction transmits through the circular polarization-selective reflective polarizer, is reflected by the half-transmissive reflective surface to become the first circularly polarized light, is reflected by the circular polarization-selective reflective polarizer, and is guided to the half-transmissive reflective surface. A part of light that has transmitted through the half-transmissive reflective surface transmits through the first quarter waveplate, transmits through the first absorptive linear polarizer, and is guided to the observer.

### BACKGROUND

### Field of the Technology

The present disclosure relates to an optical system and a display apparatus having the same, such as a wearable display apparatus.

### Description of the Related Art

Conventionally, as an optical system capable of achieving a wide angle of view and a thin configuration suitable for a wearable display device such as a head-mounted display (HMD), a polarization optical system has been known that includes coaxially arranged optical surfaces and uses polarization to selectively guide light having overlapping optical paths to an exit pupil. U.S. Patent Application Publication No. 2018/0299676 discloses a configuration in which a half-transmissive reflective surface is disposed on the display light incident side and a circular polarization-selective reflective polarizer is disposed on the exit pupil side to form overlapping optical paths.

### SUMMARY

An optical system according to one aspect of the present disclosure may be configured to guide light from a display element configured to display an image to an observer. The optical system may include, in order from a display element side toward an observer side, a circular polarization-selective reflective polarizer configured to reflect first circularly polarized light having a polarization direction of a first rotational direction, a half-transmissive reflective surface, a first quarter waveplate, and a first absorptive linear polarizer. The optical system may have an optical path in which second circularly polarized light having a polarization direction of a second rotational direction opposite to the first rotational direction transmits through the circular polarization-selective reflective polarizer, is reflected by the half-transmissive reflective surface to become the first circularly polarized light, is reflected by the circular polarization-selective reflective polarizer, and is guided to the half-transmissive reflective surface. A part of light that has transmitted through the half-transmissive reflective surface may transmit through the first quarter waveplate, transmit through the first absorptive linear polarizer, and be guided to the observer. A display apparatus having the above optical system also constitutes another aspect of the present disclosure.

Features of the present disclosure will become apparent from the following description of embodiments with reference to the attached drawings. The following description of embodiments will be described by way of example.

### BRIEF DESCRIPTION OF THE DRAWINGS

FIG. 1 is a schematic diagram illustrating a configuration of a principal part of a display apparatus according to a first embodiment.

FIGS. 2A and 2B are diagrams illustrating changes in basic polarization states and optical paths in an optical system used in the display apparatus according to the first embodiment.

FIG. 3 is a diagram illustrating another example of an imaging optical element.

FIG. 4 is a schematic diagram illustrating a configuration of a principal part of a display apparatus according to a second embodiment.

FIGS. 5A and 5B are diagrams illustrating changes in polarization states and optical paths in an optical system used in the display apparatus according to the second embodiment.

FIG. 6 is a schematic diagram illustrating a configuration of a principal part of a display apparatus according to a third embodiment.

FIGS. 7A and 7B are diagrams illustrating changes in polarization states and optical paths in an optical system used in the display apparatus according to the third embodiment.

FIG. 8 is a diagram illustrating an example of a binocular display apparatus.

### DESCRIPTION OF THE EMBODIMENTS

Referring now to the accompanying drawings, a detailed description will be given of embodiments according to the present disclosure. Corresponding elements in respective figures will be designated by the same reference numerals, and a duplicate description thereof will be omitted.

### First Embodiment

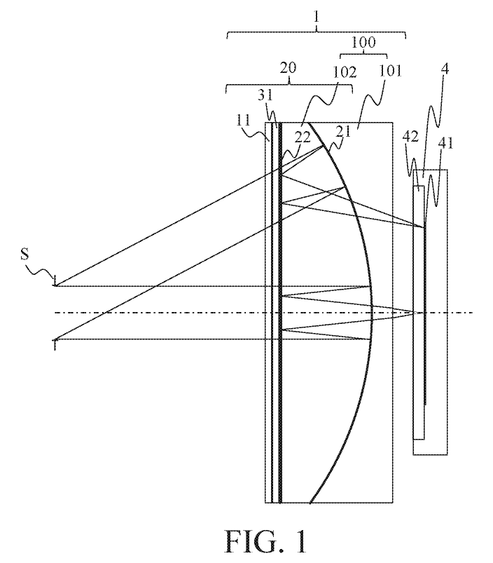

FIG. 1 is a schematic diagram illustrating a configuration of a principal part of a display apparatus according to the present embodiment. The display apparatus includes an optical system 1 and a display element 4 that displays an image.

The optical system 1 is configured to guide light from the display element 4 to an observer. The optical system 1 includes an imaging optical element 100 that includes a plano-concave lens 101 and a plano-convex lens 102. The optical system 1 further includes a polarization operation unit 20. The polarization operation unit 20 includes, in order from the display element 4 side toward the observer side (an exit pupil S side), a circular polarization-selective reflective polarizer 21, a half-transmissive reflective surface 22, a quarter waveplate (first quarter waveplate) 31, and an absorptive linear polarizer (first absorptive linear polarizer) 11.

The display element 4 includes, for example, a circularly polarized light emitting element, a liquid crystal panel, or an organic EL panel. The display element 4 includes a display surface 41 and a light-transmitting portion 42 including cover glass or the like, and in the present embodiment emits clockwise circularly polarized light (second circularly polarized light). In the present embodiment, the display element 4 emits clockwise circularly polarized light; however, the present disclosure is not limited to this example. As long as clockwise circularly polarized light can enter the circular polarization-selective reflective polarizer 21, the display element 4 may emit unpolarized light or linearly polarized light vibrating in a direction parallel to the paper plane, as described below. In this case, however, a quarter waveplate, an absorptive linear polarizer, or the like is provided on the display element 4 side of the circular polarization-selective reflective polarizer 21. Therefore, using, as the display element 4, an element that itself emits circularly polarized light can increase light utilizing efficiency of the entire display apparatus, and reduce power consumption.

Light from an image displayed on the display surface 41 (display light) travels toward the optical system 1 via the light-transmitting portion 42 and is guided to the exit pupil S through the optical system 1. The position of the exit pupil S represents a position at which an optical axis intersects a principal ray of a light beam guided to the exit pupil S from a maximum image height on the display surface 41.

The circular polarization-selective reflective polarizer 21 is an element that reflects circularly polarized light having a predetermined rotational direction (counterclockwise direction in the present embodiment) in a first wavelength band (visible light region in the present embodiment) and transmits other light. The half-transmissive reflective surface 22 is an element that transmits a part of incident light and reflects another portion thereof regardless of polarization. The ratio between transmission and reflection of light incident on the half-transmissive reflective surface 22 may not be 1:1, and may be, for example, 3:7 or 7:3. The ratio between transmission and reflection may differ according to a polarization state. The quarter waveplate 31 is a wavelength plate (waveplate) that provides a phase difference of λ/4 between two orthogonal polarized light components. The linear polarizer 11 is a polarizer that transmits predetermined linearly polarized light and absorbs linearly polarized light orthogonal to the predetermined linearly polarized light.

The circular polarization-selective reflective polarizer 21 is formed, for example, of a cholesteric liquid crystal, and in the present embodiment is formed between the plano-concave lens 101 and the plano-convex lens 102. The half-transmissive reflective surface 22 is formed between the circular polarization-selective reflective polarizer 21 and the quarter waveplate 31. This configuration properly adjusts the polarization direction of light in the first wavelength band emitted from the display element 4 with respect to the circular polarization-selective reflective polarizer 21, and makes it possible to fold the optical path.

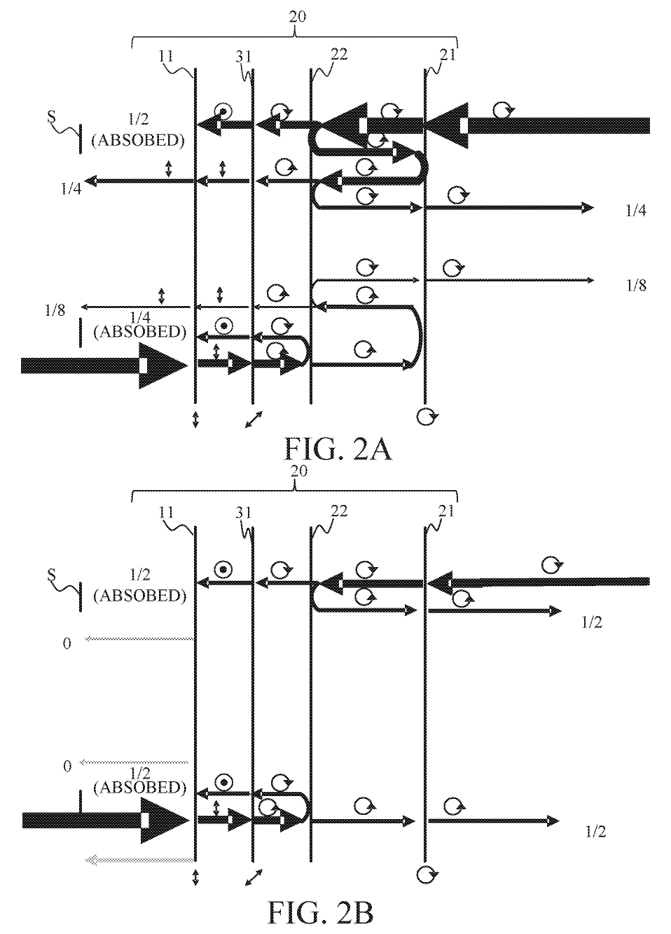

FIGS. 2A and 2B are diagrams illustrating changes in basic polarization states and optical paths in the optical system 1.

FIG. 2A illustrates changes in polarization states and optical paths of light in the first wavelength band in the polarization operation unit 20. The upper side illustrates an optical path when light (display light) is incident from the right side of FIG. 2A, and the lower side illustrates an optical path when light (external light) is incident from the left side of FIG. 2A. A description below the quarter waveplate 31 indicates a tilt of a slow axis when viewed from the exit pupil S side, and a description below the linear polarizer 11 indicates an orientation of a transmission axis (polarization transmission axis). The linear polarizer 11 transmits linearly polarized light whose electric field vibrates in a direction parallel to the paper plane (a first direction). The quarter waveplate 31 is disposed such that the slow axis thereof is tilted by +45° (rotated clockwise by 45°) with respect to the transmission axis of the linear polarizer 11. A description below the circular polarization-selective reflective polarizer 21 indicates a transmission direction (clockwise direction in the present embodiment). In the present embodiment, the quarter waveplate 31 is disposed such that the slow axis thereof is tilted by +45° relative to the transmission axis; however, the present disclosure is not limited to this example. The quarter waveplate 31 and the linear polarizer 11 may be arranged such that a relationship between the slow axis and the transmission axis causes transmission through the linear polarizer 11 to be minimized after circularly polarized light having a predetermined rotational direction and transmitting through the circular polarization-selective reflective polarizer 21 and the half-transmissive reflective surface 22 passes through the quarter waveplate 31.

An optical path in the polarization operation unit 20 will be described. For a simple description, the following conditions (1) to (4) are assumed.
(1) In a first wavelength band, the circular polarization-selective reflective polarizer 21 reflects 100% of counterclockwise circularly polarized light (first circularly polarized light) and transmits 100% of clockwise circularly polarized light, which is opposite to the counterclockwise direction. In wavelength bands other than the first wavelength band, the circular polarization-selective reflective polarizer 21 transmits 100% of light regardless of polarization direction.
(2) The half-transmissive reflective surface 22 reflects 50% of incident light and transmits the remaining 50% regardless of wavelength or polarization state. Absorption is 0%.
(3) The quarter waveplate 31 converts circularly polarized light in the first wavelength band into linearly polarized light whose vibration direction is along one of axes oriented at ±45° relative to the slow axis.
(4) The linear polarizer 11 transmits 100% of light polarized in a direction parallel to a transmission axis (a direction parallel to the paper plane) and absorbs 100% of light polarized in a direction perpendicular to the transmission axis (a direction perpendicular to the paper plane).

First, an optical path of light incident on the polarization operation unit 20 from the right side of the drawing, that is, from the display element 4 side, will be described. All clockwise circularly polarized light incident from the right side (a light amount of 1 relative to incident light) transmits through the circular polarization-selective reflective polarizer 21 and travels toward the half-transmissive reflective surface 22. Half of the clockwise circularly polarized light traveling toward the half-transmissive reflective surface 22 (a light amount of 1/2) transmits through the half-transmissive reflective surface 22 and travels toward the quarter waveplate 31. The remaining half (a light amount of 1/2) is reflected by the half-transmissive reflective surface 22, becomes counterclockwise circularly polarized light, and travels toward the circular polarization-selective reflective polarizer 21.

The clockwise circularly polarized light traveling toward the quarter waveplate 31 is converted by the quarter waveplate 31 into linearly polarized light vibrating in a direction perpendicular to the paper plane, enters the linear polarizer 11, and is absorbed, resulting in a light amount of 0.

All of the counterclockwise circularly polarized light traveling toward the circular polarization-selective reflective polarizer 21 (a light amount of 1/2) is reflected by the circular polarization-selective reflective polarizer 21 and travels toward the half-transmissive reflective surface 22. Half of the counterclockwise circularly polarized light traveling toward the half-transmissive reflective surface 22 (a light amount of 1/4) transmits through the half-transmissive reflective surface 22 and travels toward the quarter waveplate 31. The remaining half (a light amount of 1/4) is reflected by the half-transmissive reflective surface 22, becomes clockwise circularly polarized light, and travels toward the circular polarization-selective reflective polarizer 21.

The counterclockwise circularly polarized light traveling toward the quarter waveplate 31 is converted by the quarter waveplate 31 into linearly polarized light vibrating in a direction parallel to the paper plane, transmits through the linear polarizer 11, and travels toward the exit pupil S.

All of the clockwise circularly polarized light traveling toward the circular polarization-selective reflective polarizer 21 (a light amount of 1/4) transmits through the circular polarization-selective reflective polarizer 21 and is emitted toward the right side of the drawing.

Due to the above configuration, an observation optical path having an overlapping optical path is formed for transmitting light through the circular polarization-selective reflective polarizer 21, reflecting the light by the half-transmissive reflective surface 22, reflecting the light by the circular polarization-selective reflective polarizer 21, and transmitting the light through the half-transmissive reflective surface 22. In this observation optical path, light receives refractive power from components in the imaging optical element 100, thereby allowing a magnified virtual image of an original image formed on the display surface 41 to be visually recognized from the position of the exit pupil S.

Next, an optical path of light incident on the polarization operation unit 20 from the left side of the drawing, that is, from the exit pupil S side, will be described. One half of unpolarized light incident from the left side (a light amount of 1/2 relative to external light) becomes linearly polarized light vibrating in a direction parallel to the paper plane, is converted by the quarter waveplate 31 into counterclockwise circularly polarized light, and travels toward the half-transmissive reflective surface 22.

Half of the counterclockwise circularly polarized light traveling toward the half-transmissive reflective surface 22 (a light amount of 1/4) is reflected by the half-transmissive reflective surface 22, becomes clockwise circularly polarized light, and travels toward the quarter waveplate 31. The remaining half (a light amount of 1/4) travels toward the circular polarization-selective reflective polarizer 21.

The clockwise circularly polarized light traveling toward the quarter waveplate 31 is converted by the quarter waveplate 31 into linearly polarized light vibrating in a direction perpendicular to the paper plane, enters the linear polarizer 11, and is absorbed (a light amount of 0).

All of the counterclockwise circularly polarized light traveling toward the circular polarization-selective reflective polarizer 21 (a light amount of 1/4) is reflected by the circular polarization-selective reflective polarizer 21 and travels toward the half-transmissive reflective surface 22. Half of the counterclockwise circularly polarized light traveling toward the half-transmissive reflective surface 22 (a light amount of 1/8) transmits through the half-transmissive reflective surface 22, is converted by the quarter waveplate 31 into light vibrating in a direction parallel to the paper plane, passes through the linear polarizer 11, and is emitted toward the left side of the drawing. In the configuration described in U.S. Patent Application Publication No. 2018/0299676, a light amount of light in the first wavelength band that is reflected by a polarization-selective reflective polarizer and emitted toward the exit pupil S side is 1/2 relative to external light. That is, according to the configuration of the present embodiment, compared with the configuration of U.S. Patent Application Publication No. 2018/0299676, the light amount of light in the first wavelength band that is reflected by the polarization-selective reflective polarizer and emitted toward the exit pupil S side can be reduced to 1/4.

FIG. 2B illustrates changes in polarization states and optical paths of light in wavelength bands other than the first wavelength band in the polarization operation unit 20.

First, an optical path of light incident on the polarization operation unit 20 from the right side of the drawing will be described. All clockwise circularly polarized light incident from the right side (a light amount of 1) transmits through the circular polarization-selective reflective polarizer 21 and travels toward the half-transmissive reflective surface 22. Half of the clockwise circularly polarized light traveling toward the half-transmissive reflective surface 22 (a light amount of 1/2) is reflected by the half-transmissive reflective surface 22, becomes counterclockwise circularly polarized light, and travels toward the circular polarization-selective reflective polarizer 21. The remaining half (a light amount of 1/2) is converted by the quarter waveplate 31 into linearly polarized light vibrating in a direction perpendicular to the paper plane, enters the linear polarizer 11, and is absorbed (a light amount of 0).

All of the counterclockwise circularly polarized light traveling toward the circular polarization-selective reflective polarizer 21 (a light amount of 1/2) is emitted toward the right side of the drawing.

Due to the above configuration, light in wavelength bands other than the first wavelength band incident from the right side does not reach the exit pupil S. In a case where the quarter waveplate 31 and the linear polarizer 11 are not provided, when the display element 4 emits display light in wavelength bands other than the first wavelength band, light having a light amount of 1/2 relative to incident light is guided to the exit pupil S without overlapping an optical path, that is, along an optical path different from the observation optical path. Therefore, ghosts or flare may occur. In contrast, in the configuration according to the present embodiment, display light in wavelength bands other than the first wavelength band emitted by the display element 4 is absorbed by the quarter waveplate 31 and the linear polarizer 11, and thereby the display light can be satisfactorily observed.

Next, an optical path of light incident on the polarization operation unit 20 from the left side of the drawing will be described. Half of unpolarized light incident on the polarization operation unit 20 from the left side (a light amount of 1/2) becomes linearly polarized light vibrating in a direction parallel to the paper plane, is converted by the quarter waveplate 31 into counterclockwise circularly polarized light, and travels toward the half-transmissive reflective surface 22.

Half of the counterclockwise circularly polarized light traveling toward the half-transmissive reflective surface 22 (a light amount of 1/4) is reflected by the half-transmissive reflective surface 22, becomes clockwise circularly polarized light, is converted by the quarter waveplate 31 into linearly polarized light vibrating in a direction perpendicular to the paper plane, enters the linear polarizer 11, and is absorbed (a light amount of 0).

The remaining half (a light amount of 1/4) transmits through the half-transmissive reflective surface 22 and enters the circular polarization-selective reflective polarizer 21. All of the light incident on the circular polarization-selective reflective polarizer 21 (a light amount of 1/4) transmits through the circular polarization-selective reflective polarizer 21 and is emitted toward the right side of the drawing.

Due to the above configuration, light in wavelength bands other than the first wavelength band incident from the left side does not reach the exit pupil S. In a case where a linear polarization-selective reflective polarizer is used, light in the entire visible light region is reflected and emitted toward the exit pupil S side, and therefore an external light ghost amount becomes larger than that of the configuration of the present embodiment.

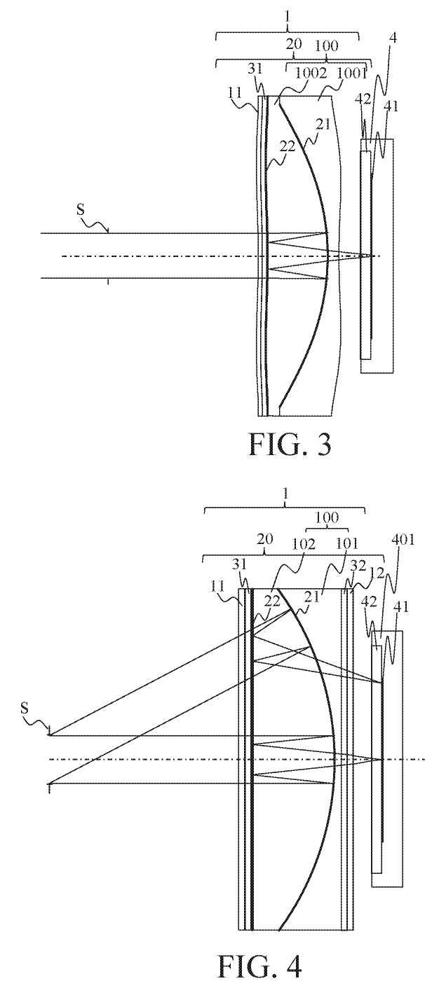

In the present embodiment, the imaging optical element 100 is described as a lens obtained by cementing the plano-concave lens 101 and the plano-convex lens 102 via the circular polarization-selective reflective polarizer 21; however, the present disclosure is not limited to this example. FIG. 3 illustrates another example of the imaging optical element 100. As illustrated in FIG. 3, the imaging optical element 100 may be a lens obtained by cementing a concave lens 1001 having curved surfaces on both sides and a convex lens 1002 having curved surfaces on both sides via the circular polarization-selective reflective polarizer 21. The imaging optical element 100 does not need to be a cemented lens, and the number of lenses constituting the imaging optical element 100 may be other than two, and various modifications are possible.

Although the circular polarization-selective reflective polarizer 21 has been described as acting on a single wavelength band, for example, a structure in which cholesteric liquid crystals having respective action wavelength bands of R, G, and B are stacked may be used. In recent years, cholesteric liquid crystals having a refractive action have also been developed, and such cholesteric liquid crystals may share a part of refractive power of a curved surface, or may be formed on a flat surface so as to function as a surface having refractive power using only cholesteric liquid crystals.

### Second Embodiment

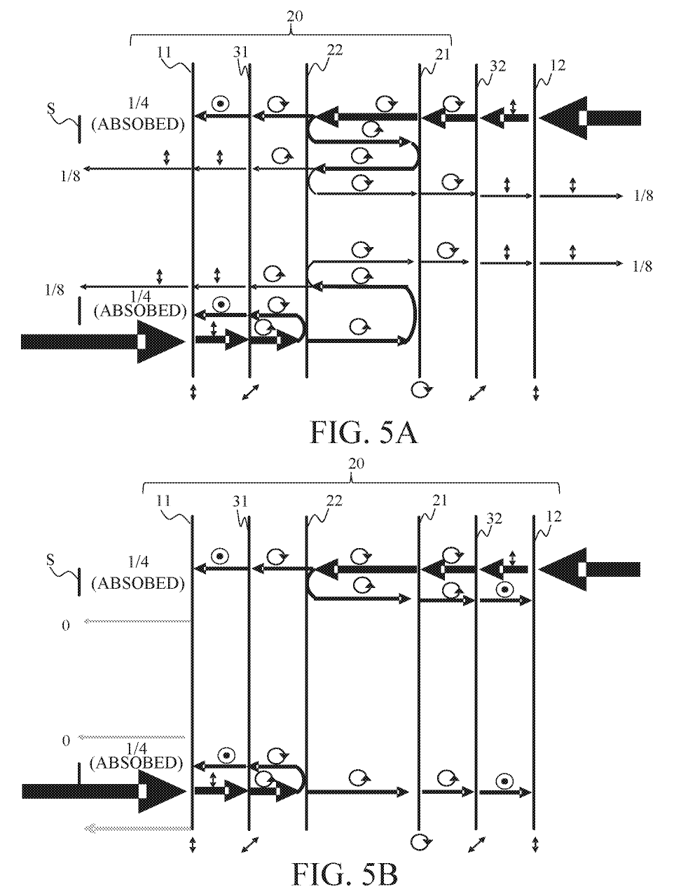

FIG. 4 is a schematic configuration diagram of a principal part of a display apparatus according to the present embodiment. FIGS. 5A and 5B are diagrams illustrating changes in polarization states and optical paths in an optical system used in the display apparatus according to the present embodiment. The present embodiment will discuss only configurations different from those of the first embodiment, and will omit a description of common configurations.

The display apparatus according to the present embodiment includes an optical system 1 and a display element 401. The display element 401 emits unpolarized light. The optical system 1 includes, in addition to the configuration of the first embodiment, a quarter waveplate (second quarter waveplate) 32 and an absorptive linear polarizer (second linear polarizer) 12. The quarter waveplate 32 and the linear polarizer 12 convert unpolarized light emitted from the display element 401 into clockwise circularly polarized light.

As illustrated in FIG. 5A, one half (1/2 light amount) of the unpolarized light emitted from the display element 401 becomes linearly polarized light vibrating in a direction parallel to the drawing plane via the linear polarizer 12, enters the quarter waveplate 32, is converted into clockwise circularly polarized light, and then enters the circular polarization-selective reflective polarizer 21. The subsequent optical path is the same as that in the case of FIG. 2A, but the observation optical path is formed in which light is guided to the exit pupil S with a light amount that is 1/8 of the incident light amount in the case of FIG. 2A. Since the rest of the case is similar to that in FIG. 2A, a description thereof will be omitted.

In FIG. 5B, light emitted from the display element 401 and reflected by the half-transmissive reflective surface 22, and external light transmitting through the half-transmissive reflective surface 22, are absorbed by the linear polarizer 12, resulting in a light amount of zero. That is, compared with the case of FIG. 2B, light that may cause stray light can be reduced.

### Third Embodiment

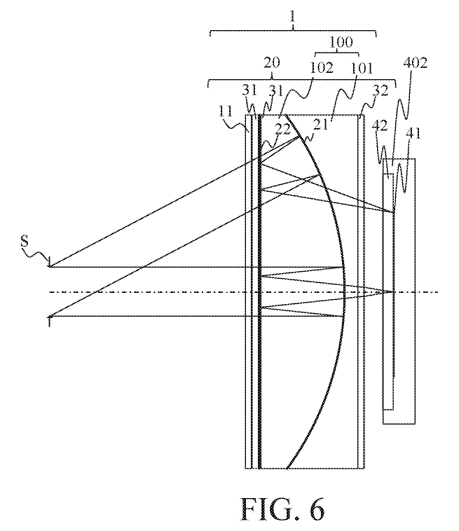

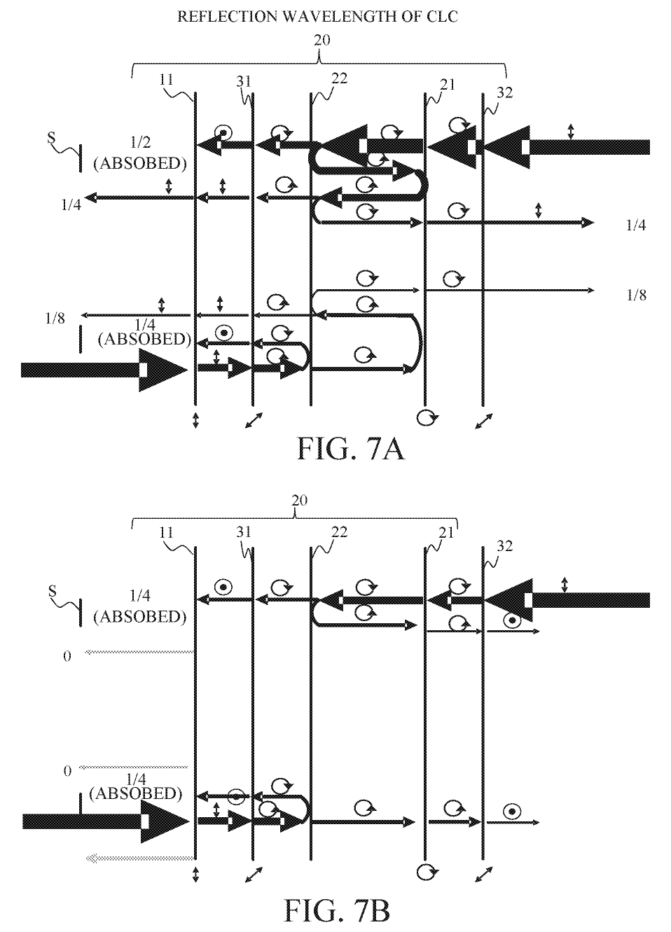

FIG. 6 is a schematic configuration diagram illustrating a principal part of a display apparatus according to the present embodiment. FIGS. 7A and 7B are diagrams illustrating changes in polarization states and optical paths in an optical system used for the display apparatus according to the present embodiment. The present embodiment will discuss only configurations different from those of the first embodiment, and will omit a description of common configurations.

The display apparatus according to the present embodiment includes an optical system 1 and a display element 402. The display element 402 emits linearly polarized light vibrating in a direction parallel to the paper plane. The optical system 1 includes, in addition to the configuration of the first embodiment, a quarter waveplate (second quarter waveplate) 32. The quarter waveplate 32 converts the linearly polarized light emitted from the display element 402 into clockwise circularly polarized light.

As illustrated in FIG. 7A, all of the linearly polarized light (light amount of 1) emitted from the display element 402 enters the quarter waveplate 32, is converted into clockwise circularly polarized light, and enters the circular polarization-selective reflective polarizer 21. The subsequent optical path is the same as that in the case of FIG. 2A. As in the cases of FIGS. 2A and 2B, an observation optical path is formed in which light is guided to the exit pupil S with a light amount that is 1/4 of the incident light amount. Therefore, compared with the case of FIG. 5A, an observation optical path is formed with less light loss in the optical system 1.

In the case of FIG. 7B, except for passing through the quarter waveplate 32, the configuration is substantially the same as that in the case of FIG. 2B, and thus a description thereof will be omitted.

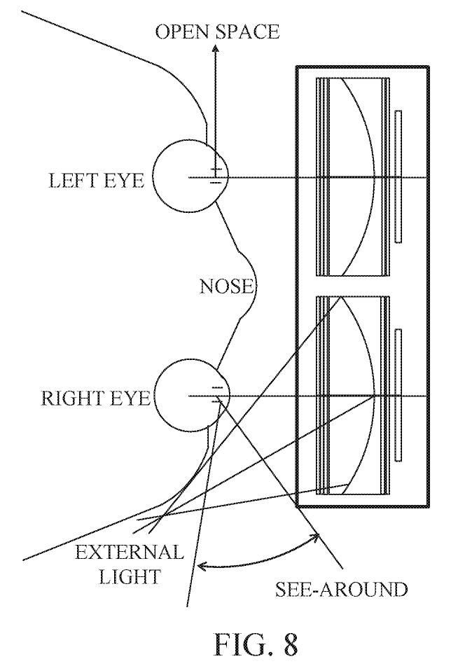

In each embodiment, the present disclosure is applied to a monocular display apparatus. However, as illustrated in FIG. 8, the present disclosure may be applied to a binocular display apparatus. Light from a first display element is guided to a left eye of an observer by a first optical system, and light from a second display element is guided to a right eye of the observer by a second optical system. In particular, a see-around configuration in which the real world outside the display apparatus is directly visible during use of the display apparatus may be used for AR or MR. In such a display apparatus, external light easily enters the optical system, and therefore the effect of reducing external light ghosting according to the present disclosure is exhibited. A minimum definition of the see-around configuration is that at least a part of a plane perpendicular to an optical axis from a center position of the exit pupil of the optical system is an open space not covered by a light-shielding wall or the like. That is, at least a part of a space provided in a direction perpendicular to the optical axis from the center position of the exit pupil of the optical system is an open space. At least a part of a region wider than 1.5 times a maximum field of view obtained by the display apparatus is an open space not covered by a light-shielding wall or the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an optical system capable of reducing external light ghosting.

This application claims the benefit of Japanese Patent Application No. 2025-078407, filed on May 9, 2025, which is hereby incorporated by reference herein in its entirety.

What is claimed is:

1. An optical system configured to guide light from a display element configured to display an image to an observer, the optical system comprising, in order from a display element side toward an observer side:
a circular polarization-selective reflective polarizer configured to reflect first circularly polarized light having a polarization direction of a first rotational direction;
a half-transmissive reflective surface;
a first quarter waveplate; and
a first absorptive linear polarizer,
wherein the optical system has an optical path in which second circularly polarized light having a polarization direction of a second rotational direction opposite to the first rotational direction transmits through the circular polarization-selective reflective polarizer, is reflected by the half-transmissive reflective surface to become the first circularly polarized light, is reflected by the circular polarization-selective reflective polarizer, and is guided to the half-transmissive reflective surface, and
wherein a part of light that has transmitted through the half-transmissive reflective surface transmits through the first quarter waveplate, transmits through the first absorptive linear polarizer, and is guided to the observer.

2. The optical system according to claim 1, wherein the first quarter waveplate and the first absorptive linear polarizer are arranged such that a relationship between a slow axis of the first quarter waveplate and a transmission axis of the first absorptive linear polarizer minimizes transmission of the second circularly polarized light through the first absorptive linear polarizer after the second circularly polarized light transmits through the circular polarization-selective reflective polarizer, transmits through the half-transmissive reflective surface, and transmits through the first quarter waveplate.

3. The optical system according to claim 2, wherein the first quarter waveplate and the first absorptive linear polarizer are arranged such that the slow axis is tilted by 45 degrees in a clockwise direction relative to the transmission axis.

4. The optical system according to claim 1, further comprising a second quarter waveplate disposed on the display element side of the circular polarization-selective reflective polarizer,
wherein linearly polarized light emitted from the display element transmits through the second quarter waveplate, becomes the second circularly polarized light, and is guided to the circular polarization-selective reflective polarizer.

5. The optical system according to claim 1, further comprising, in order from the display element side toward a circular polarization-selective reflective polarizer side, a second absorptive linear polarizer and a second quarter waveplate,
wherein unpolarized light emitted from the display element transmits through the second absorptive linear polarizer to become linearly polarized light, transmits through the second quarter waveplate to become the second circularly polarized light, and is guided to the circular polarization-selective reflective polarizer.

6. The optical system according to claim 1, wherein, of the second circularly polarized light, light that transmits through the circular polarization-selective reflective polarizer, is reflected by the half-transmissive reflective surface to become the first circularly polarized light, is reflected by the circular polarization-selective reflective polarizer, and transmits through the half-transmissive reflective surface, transmits through the first quarter waveplate to become first linearly polarized light vibrating in a first direction, transmits through the first absorptive linear polarizer, and is guided to the observer, and
wherein, of the second circularly polarized light, light that transmits through the circular polarization-selective reflective polarizer and transmits through the half-transmissive reflective surface transmits through the first quarter waveplate to become second linearly polarized light vibrating in a second direction orthogonal to the first direction and is absorbed by the first absorptive linear polarizer.

7. The optical system according to claim 1, wherein, of light incident from the observer side, light that transmits through the first absorptive linear polarizer to become first linearly polarized light vibrating in a first direction, transmits through the first quarter waveplate to become the first circularly polarized light, and is reflected by the half-transmissive reflective surface becomes the second circularly polarized light, transmits through the first quarter waveplate to become second linearly polarized light vibrating in a second direction orthogonal to the first direction, and is absorbed by the first absorptive linear polarizer.

8. The optical system according to claim 1, wherein the circular polarization-selective reflective polarizer reflects the first circularly polarized light in a first wavelength band and transmits light in a wavelength band different from the first wavelength band.

9. A display apparatus comprising:
a display element configured to display an image; and
an optical system configured to guide light from the display element to an observer,
wherein the optical system includes, in order from a display element side toward an observer side:
a circular polarization-selective reflective polarizer configured to reflect first circularly polarized light having a polarization direction of a first rotational direction;
a half-transmissive reflective surface;
a first quarter waveplate; and
a first absorptive linear polarizer,
wherein the optical system has an optical path in which second circularly polarized light having a polarization direction of a second rotational direction opposite to the first rotational direction transmits through the circular polarization-selective reflective polarizer, is reflected by the half-transmissive reflective surface to become the first circularly polarized light, is reflected by the circular polarization-selective reflective polarizer, and is guided to the half-transmissive reflective surface, and
wherein a part of light that has transmitted through the half-transmissive reflective surface transmits through the first quarter waveplate, transmits through the first absorptive linear polarizer, and is guided to the observer.

10. The display apparatus according to claim 9, wherein the display element emits the second circularly polarized light.

11. The display apparatus according to claim 9, wherein the display element emits linearly polarized light.

12. The display apparatus according to claim 9, wherein the display element emits unpolarized light.

13. The display apparatus according to claim 9, wherein the display element includes a first display element and a second display element, and
wherein the optical system includes a first optical system configured to guide light from the first display element to the observer and a second optical system configured to guide light from the second display element to the observer.

14. The display apparatus according to claim 9, wherein at least a part of space provided in a direction perpendicular to an optical axis from a center position of an exit pupil of the optical system is an open space.
